(19) United States
(12) Patent Application Publication
(10) Pub. No.: US 2025/0259203 A1
(43) Pub. Date: Aug. 14, 2025

(54) SYSTEM AND METHOD OF PROMOTING OPERATOR FOCUS THROUGH SYSTEMATIC POSITIVE REINFORCEMENT

(71) Applicant: GM Global Technology Operations LLC, Detroit, MI (US)

(72) Inventors: Armando Antonio Beltran Pacheco, Rochester Hills, MI (US); Azeem Sarwar, Rochester Hills, MI (US)

(21) Appl. No.: 18/441,045

(22) Filed: Feb. 14, 2024

(51) Int. Cl. G06Q 30/0235; G08B 21/04

(52) U.S. Cl. CPC G06Q 30/0235; G08B 21/0423

(57) ABSTRACT

A method and system of promoting operator focus through systematic positive reinforcement. The method includes receiving sensor data containing operator features; analyzing the operator features to determine the operator is in an alert state; determining a duration of alert time the operator remains in the alert state; and issuing a first level positive reinforcement feedback (1L PRF) in response to the operator remaining in the alert state equal to a sustained attention threshold (AThreshold). The method further includes issuing a second level positive reinforcement feedback (2L PRF) when the number of 1L PFR issued is equal to a first predetermined first value (K1). The method further includes issuing a third level positive reinforcement feedback (3L PRF) when the number of 2L PFR issued is equal to a second predetermined calibration value (K2).

### INTRODUCTION

The present disclosure generally relates to operator distraction mitigation in motor vehicles, and more particularly to a system and method of promoting operator focus through systematic positive reinforcement.

Modern vehicles have Driver Monitoring Systems (DMS) for detecting when an operator becomes drowsy, distracted, or generally lacks awareness when operating a vehicle. Such systems are known to include in-cabin sensors, such as an image cameras, focused on the operator of the vehicle to capture images of features of the operator that are indicative of the operator's state of distraction. Such operator features may include the position, orientation, and movement of the operator's head, eye position and gaze, and ocular data. For example, a DMS can be configured to monitor the eye-lid movements of the operator and determine when the operator appears to be drowsy. In response to the operator determined to be drowsy, the DMS may initiate a warning to the operator in a form of a visual alert such as flashing a warning light, an audial alert such as an alarm sound, and/or hepatic warning by vibrating a component of the vehicle such as the steering wheel or seat.

While DMS achieve their objectives of alerting the operator when the operator has been determined to be distracted or inattentive, there is a need for a system and method to promote or maintain operator focus while operating the vehicle to prevent operator distraction and/or inattentiveness.

### SUMMARY

According to several aspects, a method of promoting operator focus through systematic positive reinforcement is provided. The method includes: (a) analyzing sensor data to determine an operator is in an alert state; (b) determining a length of alert time the operator remains in the alert state; (c) determining the length of alert time is greater than a predetermine Attention Threshold (AThreshold); and (d) issuing a first level positive reinforcement feedback (1L PRF) in response to the length of alert time is greater than the predetermine Attention Threshold (AThreshold).

In an additional aspect of the present disclosure, the method further includes repeating steps (a) through (d); determining a number of consecutive 1L PRF issued; and issuing a second level positive reinforcement feedback (2L PRF) when the number of consecutive 1L PFR issued is equal to a first predetermined calibration value (K1).

In another aspect of the present disclosure, the method further includes determining a number of consecutive 2L PRF issued; and issuing a third level positive reinforcement feedback (3L PRF) when the number of consecutive 2L PFR issued is equal to a second predetermined calibration value (K2).

In another aspect of the present disclosure, the 1L PRF comprises an audible chime; the 2L PRF comprises an audible cheer; and the 3L PRF comprises at least one of a personalized message and an accumulable point redeemable for a service or item of monetary value.

In another aspect of the present disclosure, the 3L PRF is based on a predetermined focus score (FS), wherein:

FS=(TT−ADT)/TT, wherein:
TT=Total Travel Time
ADT=Accumulated Distraction time

In another aspect of the present disclosure, the 1L PRF and the 2L PRF are executed by an infotainment unit of a vehicle.

In another aspect of the present disclosure, the method further includes analyzing sensor data to determine a distraction event (DE); determining a distraction duration (DD) of the DE; determining the DD is greater than a predetermine distraction threshold (DT); and resetting the number of consecutive 1L PRF issued to zero in response to the DD is greater than the DT.

In another aspect of the present disclosure, analyzing sensor data to determine an operator is in an alert state includes analyzing sensor data to determine whether the operator is exhibiting a predetermined distracted behavior; determining a distracted time duration the operator is exhibiting the predetermine distracted behavior; and determining the operator is in an alert state in response to one of: (i) the operator is determined to not exhibit the predetermined distracted behavior, and (ii) the distracted time duration is less than a predetermined distraction threshold (DT).

In another aspect of the present disclosure, the method further includes issuing at least one of the 1L PRF, the 2L PRF, and the 3L PRF in response to the 1L PFR being equal to a random value greater than the first predetermined calibration value (K1).

In another aspect of the present disclosure, at least one of: (i) the first level positive reinforcement feedback (1L PRF) is issued on an aleatory basis and (ii) the second level positive reinforcement feedback (2L PRF) is issued on an aleatory basis.

According to several aspects, a system for promoting operator focus through systematic positive reinforcement is provided. The system includes at least one sensor configured to gather information on an operator of a vehicle; a control module configured to: analyze the gathered information to determine the operator is in an alert state, determine a duration of alert time the operator remains in the alert state, and issue a first level positive reinforcement feedback (1L PRF) in response to the duration of alert time is equal to a predetermined sustained attention threshold (AThreshold).

In an additional aspect of the present disclosure, the control module is further configured to determine a number of consecutive 1L PRF issued and issue a second level positive reinforcement feedback (2L PRF) when the number of consecutive 1L PFR issued is equal to a first predetermined first value (K1).

In another aspect of the present disclosure, the system further includes an infotainment unit in communication with the control module. The infotainment unit is configured to issue the 1L PRF in the form of a chime and issue the 2L PRF in the form of a cheer.

In another aspect of the present disclosure, the control module is further configured to determine a number of consecutive 2L PRF issued and issue a third level positive reinforcement feedback (3L PRF) when the number of consecutive 2L PFR issued is equal to a second predetermined calibration value (K2).

In another aspect of the present disclosure, the system further includes a reward system configured to issue the 3L PRF in the form of reward points redeemable for a service or an item of monetary value.

According to several aspects, a non-transitory computer readable medium comprising instructions stored thereon for promoting operator focus through systematic positive reinforcement, that upon execution by a processor, cause the processor to: receive sensor data containing operator features; analyze the operator features to determine an operator is in an alert state; determine a duration of alert time the operator remains in the alert state; and issue a first level positive reinforcement feedback (1L PRF) in response to the duration of time is equal to a predetermine sustained attention threshold (AThreshold).

In an additional aspect of the present disclosure, the non-transitory computer readable medium further includes instructions to cause the processor to determine a number of consecutive 1L PRF issued and issue a second level positive reinforcement feedback (2L PRF) when the number of consecutive 1L PFR issued is equal to a first predetermined first value (K1).

In another aspect of the present disclosure, the computer readable medium further includes instructions to cause the processor to determine a number of consecutive 2L PRF issued and issue a third level positive reinforcement feedback (3L PRF) when the number of consecutive 2L PFR issued is equal to a second predetermined calibration value (K2).

In another aspect of the present disclosure, the non-transitory computer readable medium further includes instructions to cause the processor to issue at least one of the 1L PRF and the 2L PRF on an aleatory basis.

In another aspect of the present disclosure, the computer readable medium further includes instructions to cause the processor to issue the 3L PRF as an accumulable reward point redeemable for a service or item of monetary value.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way

FIG. 1 is functional diagram of a vehicle having a system of promoting operator focus through systematic positive reinforcement, according to an exemplary embodiment;

FIG. 2 is a functional block diagram of the system for promoting operator focus through systematic positive reinforcement, according to an exemplary embodiment; and

FIG. 3 is a flow diagram of a method of promoting operator focus through systematic positive reinforcement, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

As used herein, the terms module, component module, control module, or controller refer to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

The connecting lines shown in the various figures contained herein are intended to represent example functional relationships and/or physical couplings between the various elements. Conventional techniques may be used for signal processing, data transmission, signaling, control, and other functional aspects of the systems (and the individual operating components of the systems) may not be described in detail herein. It should be noted that many alternative or additional functional relationships or physical connections may be present in an embodiment of the present disclosure.

Driver Monitoring Systems (DMS), also known as operator distraction detection systems, are important for addressing the issue of distracted vehicle operators. However, the challenge lies in not just detecting when an operator is already distracted, but in preventing operator distraction. The following disclosure provides a system and method of promoting operator focus and increasing operator attention span based on systematic behavior positive reinforcement with personalized feedback and/or rewards. Positive reinforcement is a technique used in psychology to promote a change in behaviors. The frequency of operator focus is increased and maintained over time by providing positive reinforcement (positive feedback) when desired operator focus is observed,.

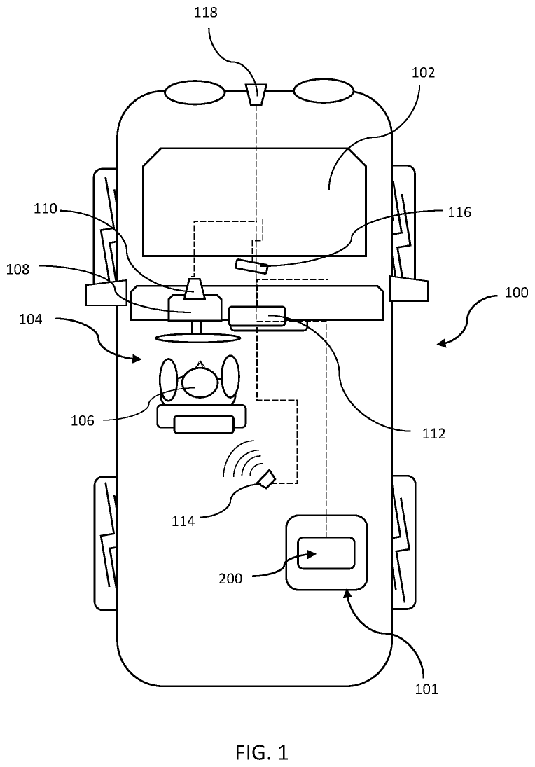

FIG. 1 is a functional diagram of a vehicle 100 having a system for promoting operator focus through systematic positive reinforcement (System 200). The System 200 may be a discrete standalone system or a component of an Advanced Driver-Assistance Systems (ADAS) 101, such as a Driver Monitoring System (DMS) 101, configured to determine a state of the operator, also referred to as an operator state, such as distracted, drowsy, inattentive, and the like. Although the vehicle 100 is shown as a sedan, it is envisioned that that connected vehicle 100 may be another type of on-road vehicle, such as a pickup truck, a coupe, a sport utility vehicle (SUV), and a recreational vehicle (RV).

The vehicle 100 generally includes a front windshield 102, an occupant compartment 104 within which an operator 106 resides. The occupant compartment 104 contains an instrument panel or dashboard 108, a cabin sensor 110 configured to capture information on the operator 106, and a feedback system 112 such as an infotainment unit 112 having an audio emitting device 114 such as a speaker 114 capable of sounding chimes, cheers, and playing prerecorded messages. The cabin sensor 110 may be positioned in a suitable location within the occupant compartment 104 to collect information or data on predetermined features of the operator, such as facial and bodily features, which can be analyzed by the System 200 to determine a state of the operator. The predetermined features of the operator are also referred to as operator features. In a non-limiting example, the cabin sensor 110 is generally located within the instrument panel 108 of the vehicle 100 and directed toward operator 106. In another non-limiting example, the cabin sensor 110 may be mounted on a rearview mirror 116 or windshield 102 of the vehicle.

The cabin sensor 110 may be that of an optical camera having CCD/CMOS active-pixel digital image sensors. Multiple optical cameras 110 may be used to capture multiple angles of the operator features and changes in the operator features to determine the operator state. The optical camera 110 may be configured to capture successive image frames. The optical camera 110 may also be that of a video camera having a processor to grab successive image frames from the video. The cabin sensor 110 may include other types of sensors that are configurable to collect information on operator features that can be analyzed to determine whether the operator is distracted or alert.

The vehicle 100 may also have at least one external sensor 118 configured to gather information or data on the exterior operating environment of the vehicle 100 that can be analyzed to determine whether the operator 106 may be distracted based on the behavior of the vehicle 100. It is preferable, the external sensor 118 is capable of capturing information on objects in the path of the vehicle 100, such as a forward vehicle, and lane markings defining a road that the vehicle 100 is driving within. It is further preferable, the external sensors 118 is capable of detecting road conditions, weather conditions, driving visibility, and the like. Information gathered by the external sensors 118 may be analyzed by the System 200 to detect demanding external conditions, like rain, snow, sleet, fog, traffic congestion, and the like. The external sensor 118 may include Light Detection and Ranging (LiDAR) sensors, ultra-sonic sensors, and the like configurable to collect information or data on the exterior operating environment of the vehicle.

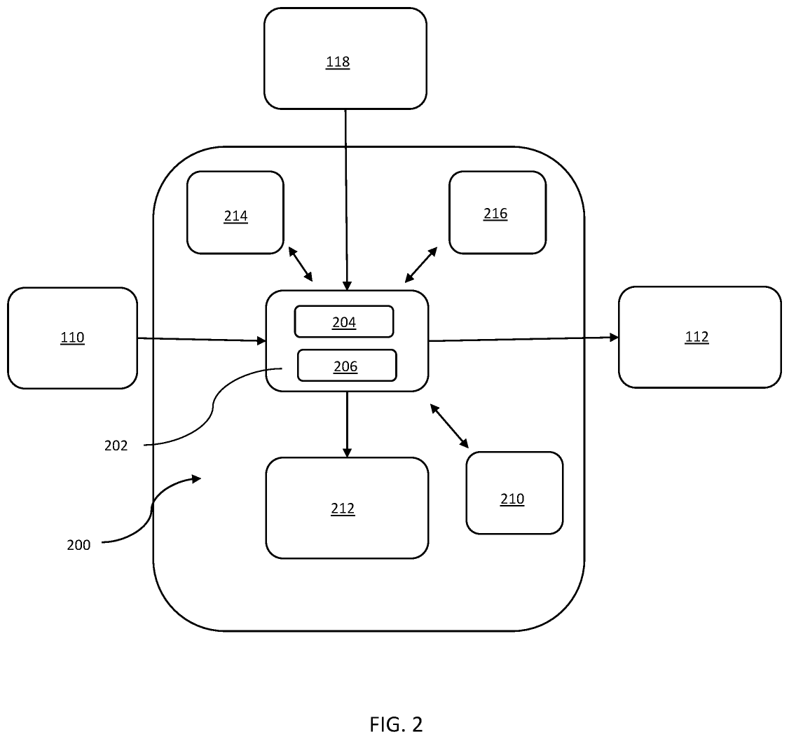

Referring to FIG. 2 together with FIG. 1, the System 200 includes a control module 202 in communication with the cabin sensor 110, infotainment unit 112, an operator profile database 210, a reward system 212, a distraction duration timer 214, and an Attention Timer (ATimer) 216. The control module 202 may also be in communication with the DMS 101 if the vehicle 100 is so equipped. In one embodiment, the control module 202 is configured to analyze information collected by the cabin sensor 110 and/or external sensor 118 to determine the operator state. In another embodiment, the control module 202 is in communications with the DMS 101 to obtain information on the operator state. The control module 202 includes at least one processor 204 and a non-transitory computer readable storage device or media 206. The non-transitory computer readable storage device or media 206 includes machine-readable instructions that when executed by the processor 204, causes the processors 204 to execute the Method 300 described below and other functions of the System 200. The operator profile database 210 may be stored on the media 206 or on a separate non-transitory computer readable storage device located on the vehicle 100 or in a remote location such as a cloud server or on a server located in a back office.

The processor 204 may be a custom made or commercially available processor, a central processing unit (CPU), a graphics processing unit (GPU), an auxiliary processor among several processors associated with the control module 202, a semiconductor-based microprocessor (in the form of a microchip or chip set), a macro processor, a combination thereof, or generally a device for executing instructions. The computer readable storage device or media 206 may include volatile and nonvolatile storage in read-only memory (ROM), random-access memory (RAM), and keep-alive memory (KAM), for example. KAM is a persistent or non-volatile memory that may be used to store various operating variables while the processor 204 is powered down. The computer-readable storage device or media 206 of the control module 202 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the control module 202.

The System 200 may retrieve an operator profile from the operator profile database 210 for analyzing the information collected by the cabin sensor 110 to determine an operator state. The control module 202 receives information from the cabin sensor and/or external sensor. The control module 202 is configured to analyze the received information to detect a Distraction Event (DE), which is when the operator is detected to exhibit a behavior indicating the operator is distracted, drowsy, inattentive, using a mobile device, or the like. A continuous period of time over which the DE is detected is referred to as a Distraction Duration (DD). The DD is compared to a predetermined allowable distraction time period, referred to as a Distraction Threshold (DT). In one embodiment, if the DD is less than the DT, the operator is determined to be in an undistracted state, also referred to as an attentive state or alert state. Conversely, if the DD is equal to or greater than the DT, the operator is determined to be in a distracted state.

In a non-limiting example, the information collected by the cabin sensor 110 may be analyzed to detect occupant behavior such as the direction of gaze and percent of closure of the eye lids of the operator 106 that may indicate the operator 106 to be in a distracted state. In one non-limiting example, the operator is determined to be distracted in response to the position of the eyes detected to be oriented away from the front windshield 102 of the vehicle 100 for a DD greater than the DT. The operator 106 may also be determined to be distracted if the eyelid position of each eye is closed for greater than or equal to a predetermined percent closure (for example 80% closure) for greater than the distracted time period threshold.

In still another non-limiting example, the control module 202 analyze information collected by the front external sensors 118 to determine the rate of approach of the vehicle 100 to an object or vehicle in the path of the vehicle 100, or the vehicle's relative position within a lane. The control module 202 may determine the operator 106 to be in a distracted state if the rate of approach of the vehicle 100 to the object is greater than a predetermined rate. The control module 202 may also determine the operator 106 to be in a distracted state if the vehicle 100 is oscillating within a lane above a predetermined frequency.

The System 200 is configured to determine an Undistracted Event (UE), which is defined as a maintained distraction-free-state or by the operator during a predetermined period of time, also referred to as Attention Threshold (AThreshold). The UE represents the period of sustained operator attention at which a positive feedback is provided. In other words, a sustained AThreshold represents the period of time that the operator's attention is sustained [i.e., no distraction events (DE) occurred having a distraction duration (DD) greater than the distraction threshold (DT)]. Once the sustained AThreshold is achieved, a positive feedback or reward is provided to the operator.

Positive feedback or a reward is provided to an operator in the following manner. A first level positive reinforcement feedback (L1 PRF) is provided every time an UE is achieved. A second level positive reinforcement feedback (L2 PRF) is provided every K1 times a L1 PRF is achieved. K1 is defined as a Personalized Number of Focus Chimes (NFC) threshold, calculated from a Focus Score (FS), which is defined below. A third level positive reinforcement feedback (L3 PRF) is provided every K2 times a L2 PRF feedback is achieved. K2 is defined as a Personalized Number of Focus Voice Cheers (NFVC) threshold, also calculated from the FS. K1 and K2 are determined based on personalized metrics that are collected and calculated over time and will define the individual attention profile of an operator. Calibrating the frequency of L2 PRF and L3 PRF with personalized threshold values of K1, K2 allows an adequate level of challenge to keep positive reinforcement effective.

A reward may be provided to the operator in the form of a Focus Score (FS) that may be converted into a physical item or service of value. A FS is defined as the total distraction free time over the travel time.

FS=(TT-ADT)/TT, where:
TT is Total Travel Time;
ADT is Accumulated Distraction time, which is the sum of the DD for all events during TT, including the DD under the DT.

### Example

FS=(55 min−9 min)/55 min=0.83

FS=(55 min−1 min)/55 min=0.98

The feedback system 112 interacts with the operator 106 by providing auditive notifications for the different levels of driving focus achieved. The feedback system 112 is configured to interact with the operator 106 in a game like mode (gamification technique) that includes a distinctive chime sound when an L1 PFR is achieved. Non-limiting examples of chimes includes default sounds such as bells or tones, and personalized sounds. The feedback system 112 may be configured to include a cheering voice message when an L2 PFR is achieved. Non-limiting examples of cheers include personalized voice messages, and prerecorded messages from friends and family members. The feedback can be fully personalized to increase the motivation of the operator. For example, chimes can be personalized to any meaningful sound, and cheering voices and messages can be prerecorded from a loved one.

Points may be presented as a reward when an L3 PFR is achieved. A distinctive sound and/or voice message may be played to indicate that points have been accumulated in the operator rewarding profile. Points may be attributed to already existing subscription services such as OnStar. Reward points can be exchanged for benefits like accessories, vehicle service discounts, and other third-party services. Points earned can be boosted by Intermittent Positive Reinforcement Algorithm IPRA for attention boost. Targeted personalization can potentially be linked to any social interaction and recognition method such as an offline social network where family and friends can provide social recognition for a positive attention profile.

The rewarding system 212 keeps track and exchange the accumulated points earned by playing the “driving focus game”, which enables real life motivation to avoid driving distraction. Making use of already existing mechanisms, like OnStar and/or My Chevrolet app, rewards points can be exchanged for benefits like accessories, vehicle services discounts, and other third part services. An attention profile of the operator 106 can also be implemented as a social credit system to provide insurance discounts and other benefits and recognitions in any social interaction network.

The operator profile database 210 stores operator data and provides calculations of personalized parameters and profile metrics to calibrate and improve the Method 300 response over time. Personalized parameters including:
Profile Metrics including:
   FS-Focus Score
   CFS-Cumulative Focus Score
   DEV-Distraction Events Variability.
   DEAT-Distraction Events Average Time
Predetermined thresholds including:
   DT-Distraction Threshold, calculated from Distraction Events Average Time (DEAT), e.g. Default 5 seconds
   AT-Sustained Attention Threshold, calculated from the Distraction Events Variability (DEV), e.g. Default 45 seconds
Calibration Levels including:
   K1-Personalized Focus Calibration, calculated from the Focus Score
   K2-Personalized Focus Calibration, calculated from the Focus Score

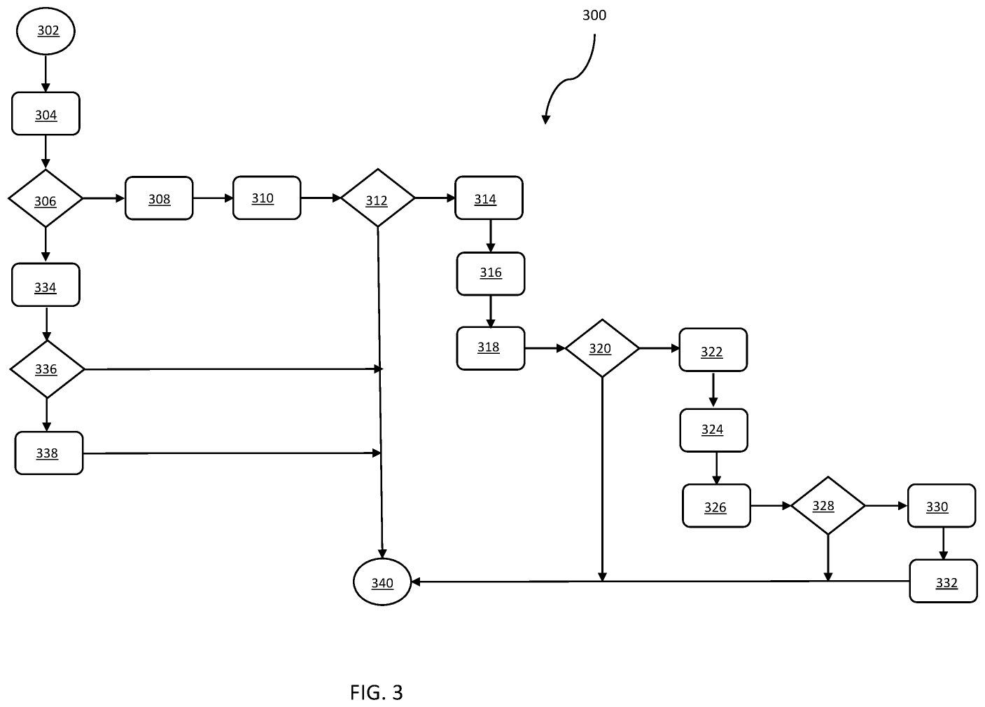

FIG. 3 is a flow diagram of an embodiment of a method of promoting driving focus through systematic positive reinforcement using time-based reinforcement (Method 300). The Method 300 begins at Block 302 with the operator operating the vehicle. Moving to Block 304, the control module 202 analyze information collected by the cabin sensors, the external sensors, and/or Driver Monitoring System (DMS) 101 to detect a Distraction Event (DE).

Proceeding to Block 306, if a DE is detected, then the Method proceeds to Block 334. At Block 334, a Distraction Duration (DD) of the DE is determined.

Proceeding to Block 336 from Block 334, if the DD is equal to or greater than a predetermined Distraction Threshold (DT), the operator is deemed distracted and the Method 300 proceeds to Block 338. At Block 338 The Attention Timer (ATimer) 216 is reset and the Method 300 ends at Block 340 or continues to reiterate starting from Block 304 if the operator continues to operate the vehicle 100.

Referring back to Block 306, if a DE is not detected, then the Method 300 proceeds to Block 308. At Block 308, the Distraction Duration Timer 214 is reset. The Method proceeds to Block 310.

At Block 310, an Increment Attention Timer 216 is started to measure a continuous period of time of an UE (i.e. DD of a DE is less than the DT). The method proceeds to Block 312.

At Block 312, if the accumulated increment attention time is equal to a predetermined Attention Threshold (AThreshold), then the Method proceeds to Block 314. Otherwise, the Method 300 ends at Block 340 or continues to reiterate starting from Block 304 if the operator continues to operate the vehicle 100

Proceeding to Block 314 from Block 312. At Block 314, the module 202 issues a first level positive reinforcement feedback (1L PRF), such as a focus chime to reward the operator. Proceeding to Block 316 from Block 314, the Attention Timer (ATimer) 216 is reset. The Method proceeds to Block 318.

At Block 318, the module 202 increases the number of focus chimes (NFC) for each time interval the operator is determined to be in an attentive state (i.e UE). In other words, the module 202 determines a number of consecutive 1L PFR issued. The Method proceeds to Block 320.

At Block 320, if the NFC (i.e. the number of consecutive 1L PFR issued) is equal to a first predetermined calibration factor (K1), the Method 300 proceeds to Block 322. At Block 322, the module 202 issues a second level positive reinforcement feedback (2L PRF), which is a focus voice cheer. The method then proceeds to Block 324.

At Block 324, the ATimer is reset and the Method 300 proceeds to Block 326. At Block 326, the module 202 increases the increment of Number of Focus Voice Cheers (NFVC) (i.e. the number of consecutive 2L PFR issued). The Method proceeds to block 328.

At Block 328, the Module 202 determines if the NFVC is equal to K2. If the NFVC is greater than a second predetermined calibration factor (K2), then the Method 300 proceeds to Block 330.

At Block 330, a third level positive reinforcement feedback (3L PRF) is rewarded. A 3L PRF may be in the embodiment of accumulable reward points that can be exchanged for benefits like accessories, vehicle services discounts, and other third part services.

The Method proceeds to Block 332. At Block 332, the ATimer is reset and the Method ends at Block 340 or continues to reiterate starting from Block 304 if the operator continues to operate the vehicle 100.

While Time-based Method 300 provides feedback by way of regular timing, an intermittent feedback mode may be provided in an aleatory basis, at random times within certain boundaries. When a consistent and stable feedback has been provided for a period of time, the time based Method 300 may switch to intermittent feedback mode. The intermittent feedback mode can also be triggered at any time an attention boost is needed. For example when the operator metrics indicated a tendency to get distracted, an aleatory reward will be sent to promote motivation and self-awareness. The goal is to maintain the operator's motivation by providing additional recognition at aleatory times.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A method of promoting operator focus through systematic positive reinforcement, comprising:
a. analyzing sensor data to determine an operator is in an alert state;
b. determining a length of alert time the operator remains in the alert state;
C. determining the length of alert time is greater than a predetermine Attention Threshold (AThreshold); and
d. issuing a first level positive reinforcement feedback (1L PRF) in response to the length of alert time is greater than the predetermine Attention Threshold (AThreshold).

2. The method of claim 1, further comprising:
repeating steps (a) through (d);
determining a number of consecutive 1L PRF issued; and
issuing a second level positive reinforcement feedback (2L PRF) when the number of consecutive 1L PFR issued is equal to a first predetermined calibration value (K1).

3. The method of claim 2, further comprising:
determining a number of consecutive 2L PRF issued; and
issuing a third level positive reinforcement feedback (3L PRF) when the number of consecutive 2L PFR issued is equal to a second predetermined calibration value (K2).

4. The method of claim 3, wherein:
the 1L PRF comprises an audible chime;
the 2L PRF comprises an audible cheer; and
the 3L PRF comprises at least one of a personalized message and an accumulable point redeemable for a service or item of monetary value.

5. The method of claim 4, wherein the 3L PRF is based on a predetermined focus score (FS), wherein:
FS=(TT−ADT)/TT, wherein:
TT=Total Travel Time
ADT=Accumulated Distraction time.

6. The method of claim 4, wherein the 1L PRF and the 2L PRF are implemented by an infotainment unit of a vehicle.

7. The method of claim 3, further comprising:
analyzing sensor data to determine a distraction event (DE);
determining a distraction duration (DD) of the DE;
determining the DD is greater than a predetermine distraction threshold (DT); and
resetting the number of consecutive 1L PRF issued to zero in response to the DD is greater than the DT.

8. The method of claim 3, wherein analyzing sensor data to determine an operator is in an alert state, comprises:
analyzing sensor data to determine whether the operator is exhibiting a predetermined distracted behavior;
determining a distracted time duration the operator is exhibiting the predetermine distracted behavior; and
determining the operator is in an alert state in response to one of:
the operator is determined to not exhibit the predetermined distracted behavior, and
the distracted time duration is less than a predetermined distraction threshold (DT).

9. The method of claim 3, further comprising:
issuing at least one of the 1L PRF, the 2L PRF, and the 3L PRF in response to the 1L PFR being equal to a random value greater than the first predetermined calibration value (K1).

10. The method of claim 3, wherein at least one of:
the first level positive reinforcement feedback (1L PRF) is issued on an aleatory basis; and
the second level positive reinforcement feedback (2L PRF) is issued on the aleatory basis.

11. A system for promoting operator focus through systematic positive reinforcement, comprising:
at least one sensor configured to gather information on an operator of a vehicle; and
a control module configured to:
analyze the gathered information to determine the operator is in an alert state,
determine a duration of alert time the operator remains in the alert state, and
issue a first level positive reinforcement feedback (1L PRF) in response to the duration of alert time is equal to a predetermined sustained attention threshold (AThreshold).

12. The system of claim 11, wherein the control module is further configured to:
determine a number of consecutive 1L PRF issued; and
issue a second level positive reinforcement feedback (2L PRF) when the number of consecutive 1L PFR issued is equal to a first predetermined first value (K1).

13. The system of claim 12, further comprising:
an infotainment unit in communication with the control module, wherein the infotainment unit is configured to issue the 1L PRF in a form of a chime and issue the 2L PRF in a form of a cheer.

14. The system of claim 13, wherein the control module is further configured to:
determine a number of consecutive 2L PRF issued; and
issue a third level positive reinforcement feedback (3L PRF) when the number of consecutive 2L PFR issued is equal to a second predetermined calibration value (K2).

15. The system of claim 14, further comprising:
a reward system configured to issue the 3L PRF in a form of reward points redeemable for a service or an item of monetary value.

16. A non-transitory computer readable medium comprising instructions stored thereon for promoting operator focus through systematic positive reinforcement, that upon execution by a processor, cause the processor to:
receive sensor data containing operator features;
analyze the operator features to determine an operator is in an alert state;
determine a duration of alert time the operator remains in the alert state; and
issue a first level positive reinforcement feedback (1L PRF) in response to the duration of time is equal to a predetermine sustained attention threshold (AThreshold).

17. The non-transitory computer readable medium of claim 16, further comprising instructions to cause the processor to:
determine a number of consecutive 1L PRF issued; and
issue a second level positive reinforcement feedback (2L PRF) when the number of consecutive 1L PRF issued is equal to a first predetermined first value (K1).

18. The non-transitory computer readable medium of claim 17, further comprising instructions to cause the processor to:
determine a number of consecutive 2L PRF issued; and
issue a third level positive reinforcement feedback (3L PRF) when the number of consecutive 2L PFR issued is equal to a second predetermined calibration value (K2).

19. The non-transitory computer readable medium of claim 18, further comprising instructions to cause the processor to:
issue at least one of the 1L PRF and the 2L PRF on an aleatory basis.

20. The computer readable medium of claim 18, further comprising instructions to cause the processor to:
issue the 3L PRF as an accumulable reward point redeemable for a service or item of monetary value.
